(19) United States
(12) Patent Application Publication
(10) Pub. No.: US 2015/0075667 A1
(43) Pub. Date: Mar. 19, 2015

(54) CARBON MACROTUBES AND METHODS FOR MAKING THE SAME

(71) Applicant: LOCKHEED MARTIN CORPORATION, BETHESDA, MD (US)

(72) Inventors: FRANCIS J. MCHUGH, Manlius, NY (US); ROBERT C. MALLORY, Baldwinsville, NY (US)

(73) Assignee: LOCKHEED MARTIN CORPORATION, BETHESDA, MD (US)

(21) Appl. No.: 14/031,300

(22) Filed: Sep. 19, 2013

(51) Int. Cl. F16L 9/00; B65H 18/00; C01B 31/04

(52) U.S. Cl. CPC F16L 9/00; C01B 31/0438; C01B 31/0484; B65H 18/00; B82Y 40/00
USPC 138/140; 156/187; 977/842

(57) ABSTRACT

A method of manufacturing a carbon macrotube includes providing at least one layer of graphene and wrapping the at least one layer of graphene around a scaffold material to form a carbon macrotube is disclosed. In other words the carbon macrotube includes at least one layer of graphene having opposed lateral edges that are spirally wrapped around itself so as to form the macrotube.

### TECHNICAL FIELD

Generally, the present invention is directed to carbon macrotubes and methods for making the same. Specifically, the present invention is directed to constructing carbon macrotubes from at least a single layer of a graphene sheet or sheets. More particularly, the present invention is directed to formation of carbon macrotubes by wrapping at least a single layer of graphene or graphene sheets made in a roll-to-roll process and wrapping the sheet or sheets around a scaffolding tube.

### BACKGROUND ART

Carbon nanomaterials have been the focus of significant research investment over the past few years. These materials have been found to have notable thermal, mechanical, optical and electrical properties. These properties include, but are not limited to, relatively high tensile strength and high electron mobility at room temperature. Carbon nanomaterials include, but are not limited to, carbon nanotubes, carbon nanostructures and combinations thereof in any ratio.

Generally, the term “carbon nanotube” (CNT, plural CNTs) refers to any of a number of cylindrically-shaped allotropes of carbon of the fullerene family including single-walled carbon nanotubes (SWNTs), double-walled carbon nanotubes (DWNTs), multi-walled carbon nanotubes (MWNTs). CNTs can be capped by a fullerene-like structure or open-ended. CNTs may include those that encapsulate other materials. CNTs may appear in branched networks, entangled networks, and combinations thereof.

Generally, carbon nanostructures (CNS) comprise a polymer-like structure comprising carbon nanotubes (CNTs) as a monomer unit, wherein the CNS may comprise a highly entangled carbon nanotube-based web-like structure that includes combinations of CNTs that are interdigitated, branched, crosslinked, and share common walls. Indeed, the carbon nanostructures may comprise carbon nanotubes (CNTs) in a network having a complex morphology. Without being bound by theory, it has been indicated that this complex morphology may be the result of the preparation of the CNS network on a substrate under CNT growth conditions at a rapid rate on the order of several microns per second. This rapid CNT growth rate coupled with the close proximity of the nascent CNTs may provide the observed branching, crosslinking, and shared wall motifs. CNS may be disposed on a substrate, filament or fiber interchangeably as CNTs because CNTs comprise the major structural component of the CNS network.

Carbon nanostructures may also refer to any carbon allotropic structure having at least one dimension in the nanoscale. Nanoscale dimensions include any dimension ranging from between 0.1 nm to about 1000 nm. Formation of such structures can be found in U.S. Publication No. 2011/0124253, which is hereby incorporated by reference.

A related area of research is focused upon graphene materials which are considered to be a subset of carbon nanomaterials. As will be further described in detail, graphene, which is an allotrope of carbon, is generally defined as carbon atoms that are arranged in a regular hexagonal pattern. Graphene may also be described as a one-atom thick layer of the mineral graphite, although multiple layers of graphene may be stacked on one another. Graphene has been found to have unique electronic, electron transport, optical, thermal, mechanical and magnetic properties, among others.

In order to take advantage of the unique properties in carbon nanomaterials and graphene materials, attempts have been made to aggregate or otherwise congregate the nanoscale materials at a macroscopic level. It is believed that by doing so the unique properties of the carbon nanomaterials can be further enhanced and/or improved. However, for example, attempts have been made to scale carbon nanostructures to a macro level by spinning carbon nanotube fibers into thread. Unfortunately, the tensile strength of such threads does not approach the tensile strength of a single wall carbon nanotube. Therefore, there is a need in the art to manufacture macroscopic structures with carbon nanotube nanomaterials and/or structures that provide the desired mechanical properties and which also exhibit the other beneficial properties of carbon nanostructures.

### SUMMARY OF THE INVENTION

In light of the foregoing, it is a first aspect of the present invention to provide carbon macrotubes and methods for making the same.

It is another aspect of the present invention to provide a method of manufacturing a carbon macrotube, comprising providing at least one layer of graphene, and wrapping the at least one layer of graphene around a scaffold material so as to form a carbon macrotube.

Yet another aspect of the present invention is a carbon macrotube, comprising at least one layer of graphene having opposed lateral edges, wherein the lateral edges are spirally wrapped around the at least one layer to form a macrotube.

### BRIEF DESCRIPTION OF THE DRAWINGS

This and other features and advantages of the present invention will become better understood with regard to the following description, appended claims, and accompanying drawings wherein:

FIG. 1 is a schematic diagram of a graphene sheet;

FIG. 2 is a schematic diagram of an apparatus for forming carbon macrotubes from a graphene sheet according to the concepts of the present invention;

FIG. 3 is a cross-sectional view, not to scale, of a composite graphene/copper sheet taken along lines 3-3 of FIG. 2 according to the concepts of the present invention;

FIG. 4 is a cross-sectional view, not to scale, of a composite polymer/graphene/copper sheet taken along lines 4-4 of FIG. 2 according to the concepts of the present invention;

FIG. 5 is a cross-sectional view, not to scale, of a composite polymer/graphene sheet taken along lines 5-5 of FIG. 2 according to the concepts of the present invention;

FIG. 6A is a cross-sectional view, not to scale, of a carbon macrotube according to the concepts of the present invention;

FIG. 6B is a cross-sectional view, not to scale, of a carbon macrotube without a scaffold tube according to the concepts of the present invention;

FIG. 7 is a cross-sectional view, not to scale, of a cable constructed from at least two carbon macrotubes made in accordance with the concepts of the present invention;

FIG. 8 is a graphical representation of tensile strength of a carbon macrotube made in accordance with the concepts of the present invention;

FIG. 9 is a graphical representation of carbon macrotube specific tensile strength according to the concepts of the present invention;

FIG. 10 is a graphical representation of carbon macrotube resistivity according to the concepts of the present invention;

FIG. 11 is a graphical representation of carbon macrotube resistivity density product according to the concepts of the present invention; and

FIG. 12 is a table of carbon macrotube properties for various structural configurations of the macrotube according to the concepts of the present invention.

### BEST MODE FOR CARRYING OUT THE INVENTION

The present invention is directed to the formation of carbon macrostructures, such as carbon macrotubes, from molecular carbon atoms. Research and development efforts have resulted in the formation of graphene and, in particular, manufacturing processes that form relatively large scale quantities of consistent and uniform sheets and/or lengths of graphene material.

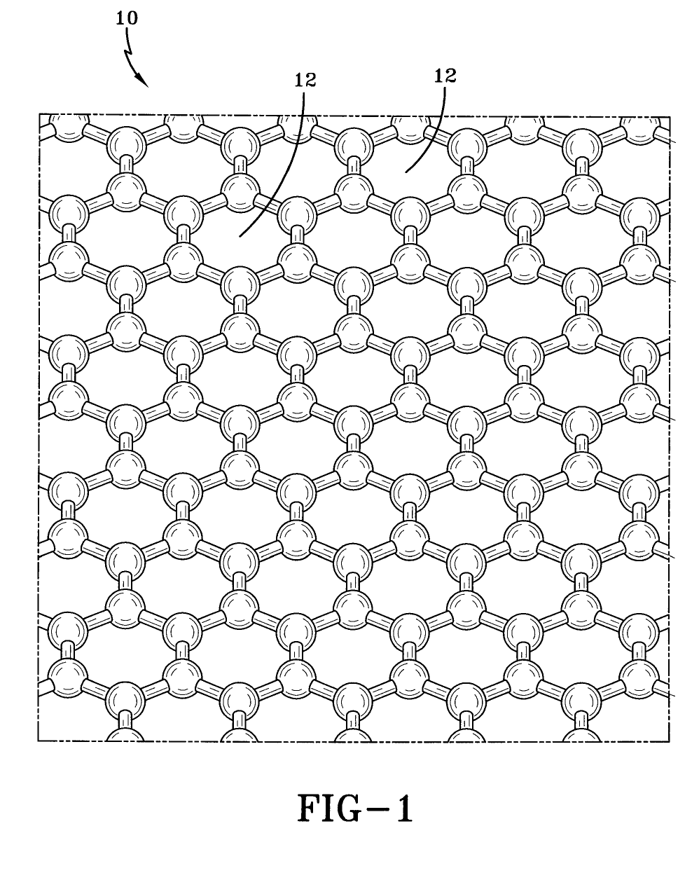

In FIG. 1 a schematic representation of a graphene sheet is designated generally by the numeral 10. The sheet 10 may be in the form of a lattice or layer represented by interconnected hexagonal rings. In the disclosed embodiments, a graphene sheet may comprise a single layer of carbon atoms, or multiple layers of carbon atoms, which may be referred to as “few layer graphene.” Skilled artisans will appreciate that single-layer or multi-layer graphene sheets may be formed, having greater thickness and correspondingly greater strength. Multiple graphene sheets can be provided in multiple layers as the sheet is grown or formed. Or multiple graphene sheets can be achieved by layering or positioning one sheet, which may be a single layer or few layer graphene, on top of another. For all the embodiments disclosed herein, a single sheet of graphene or multiple graphene sheets may be used and any number of layered sheets may be used. Testing reveals that multiple layers of graphene maintain their integrity and function as a result of self-adhesion. This improves the strength of the sheet and in some cases electron flow performance. As seen in FIG. 1, the carbon atoms of the graphene sheet 10 may define a repeating pattern of hexagonal ring structures (benzene rings) constructed of six carbon atoms, which form a honeycomb lattice of carbon atoms. An interstitial aperture 12 is formed by each six-carbon atom ring structure in the sheet and this interstitial aperture is less than one nanometer across. Indeed, skilled artisans will appreciate that the interstitial aperture is believed to be about 0.23 nanometers across its longest dimension. Although an ideal configuration of the graphene sheet is shown in FIG. 1, skilled artisans will appreciate that imperfections in the bonding of carbon atoms to one another may result in corresponding imperfections in the sheet or sheets and, as a result, the interstitial aperture size may vary accordingly.

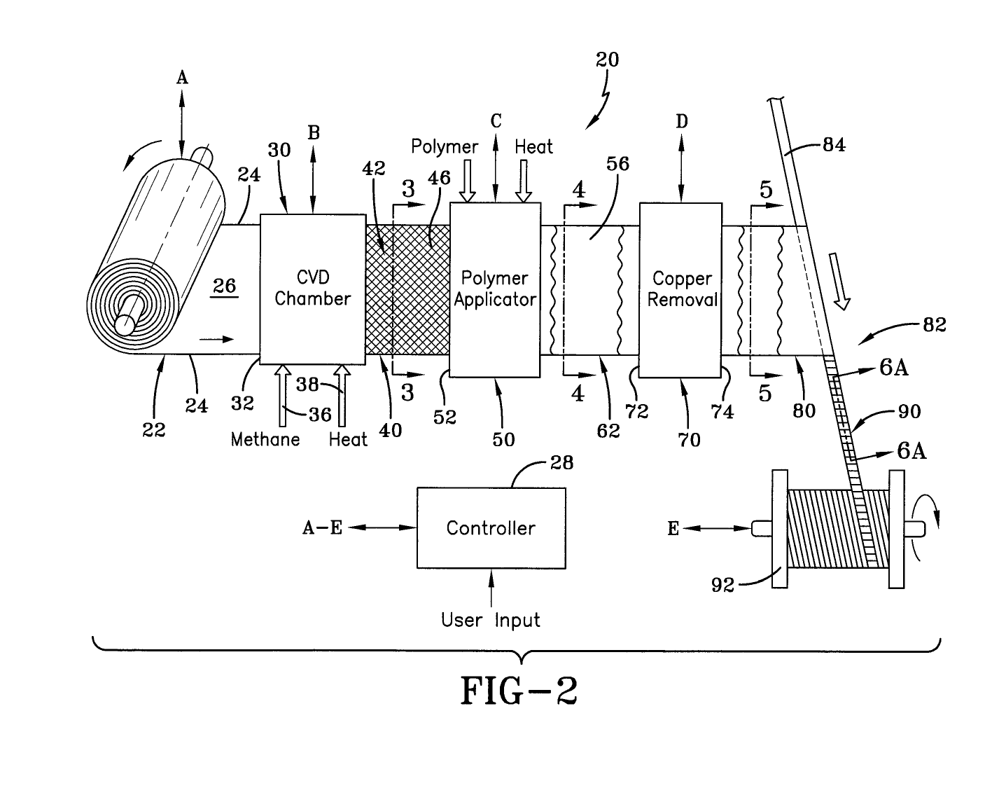

Referring now to FIG. 2, it can be seen that an apparatus for forming a carbon macrotube from a graphene sheet 10 is designated generally by the numeral 20. Skilled artisans will appreciate that the components utilized in the apparatus may be modified as needed to obtain particular properties of the end product obtained in the manufacturing process.

Initially, a copper foil 22, which may also be referred to as a copper sheet, is provided in roll form or similar configuration with a desired thickness or may be drawn down to a desired shape and thickness, and may have coatings, added alloys or treatments so as to facilitate the manufacturing process. The copper foil 22 provides for opposed edges 24 and a carrier surface 26. In some embodiments, the copper foil 22 may have a thickness of between 10 microns to 25 microns. In other embodiments, the foil 22 may have a thickness of between 10 microns to 100 microns. The copper foil is flexible and capable of being pulled or otherwise transferred through the apparatus.

A controller 28 is provided to control the various components of the apparatus 20. For example, a let-off mechanism, which may or may not be motorized, controls dispensing of the copper foil 22 and generates an output and receives input from the controller 28 so as to control parameters such as take-off speed, i.e., the speed in which the copper foil is delivered to the other components of the apparatus and the like. Other inputs and outputs are designated by alphabetic letters and the controller may also receive user input so as to allow control by a user of the various components of the apparatus in preparing the end product. Skilled artisans will appreciate that the controller 28 provides the necessary hardware, software and memory for implementing the various operational aspects of the apparatus 20.

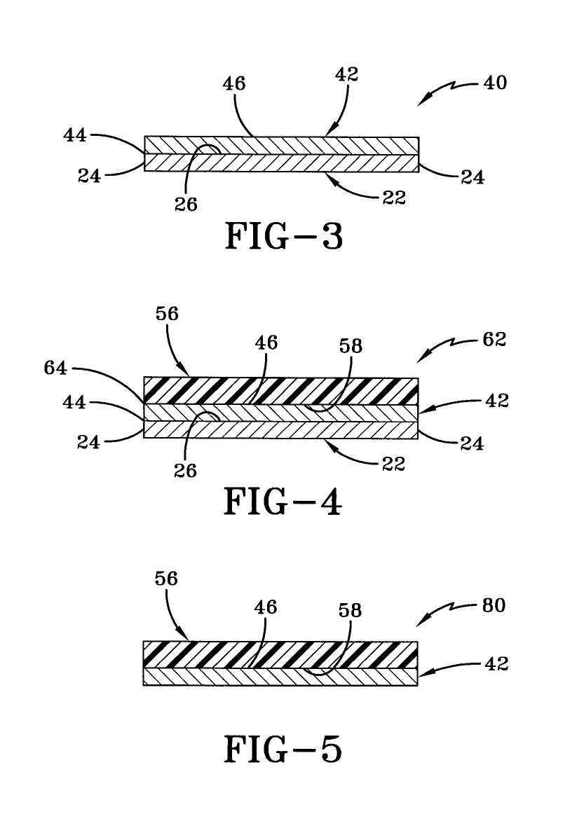

A carbon vapor deposition (CVD) chamber is designated generally by the numeral 30 and provides an inlet 32. The copper foil 22 is received in the inlet 32 and carbon material is disposed on the carrier surface for formation of a graphene sheet, such as shown in FIG. 1 and described above. The chamber 30 includes at least a methane input 36 which provides the source of carbon atoms to be disposed on the copper sheet and a heat input 38. The chamber 30 receives input from the controller 28 and also generates output signals so as to allow the controller to monitor operation of the chamber during deposition and other times. By controlling the various input parameters such as the input of methane and the input of heat and other related parameters known to those skilled in the art, the chamber 30 generates and forms a graphene sheet 42 which is similar to the sheet 10, but which is disposed on the copper foil 22. As a result, a composite graphene/copper sheet 40 is formed. In one embodiment, the heat input may range from about 700° to 1100° centigrade. In one embodiment, methane (CH₄) and H₂ are flowed over the copper foil at selected pressures and/or flow rates. After the graphene has bonded to the copper foil, the bonded materials are cooled in a prescribed manner During the deposition process, bonds 44, which are represented by the line between the foil 22 and the sheet 42 as seen in FIG. 3, are formed between the carrier surface 26 of the copper foil 22 and the disposed carbon atoms which constitute the graphene sheet 42. These bonds are essentially formed on the underside of the graphene sheet 42 and on the carrier surface 26 of the foil 22. The bonds develop during the deposition process between the carbon and copper atoms. The bonds are sometimes referred to as a Van der Waals interactions or forces. These bonding forces are of the first order and may be represented by a distributed non-linear spring stiffness. As described above, the deposition process may produce a single atomic layer of graphene, few layer graphene or multiple layers of graphene. In any event, the composite graphene/copper sheet 40 provides for a top side 46.

Once the composite graphene/copper sheet 40 completes any post-processing steps required after exiting the chamber 30, it then enters a polymer applicator designated generally by the numeral 50. The device 50 includes an inlet 52 for receiving the sheet 40. The device 50 receives a polymer material and heat along with the control input C from the controller 28 so as to form a polymer sheet 56 which adheres or is otherwise bonded to the composite graphene/copper sheet 40. In the present embodiment the polymer material may be poly (methyl methacrylate) (PMMA). Other polymeric material utilizing silicones may also be used. In some embodiments the thickness of the polymer sheet 56 may range from 10 microns to 25 microns. In other embodiments the thickness of the polymer sheet may range from 10 microns to 100 microns. Skilled artisans will appreciate that selection of a material and its thickness may be dependent upon compatibility with the discussed processing steps and compatibility with the properties of the graphene and copper materials of the other layers. In some embodiments, the polymer material may be heated to flow in a liquid state on to the sheet 40. In other embodiments, the polymer material may be provided in an appropriately sized sheet, which may be withdrawn from a roll, which is laminated or otherwise applied to the sheet 40. In some, but not all embodiments, it is desired that the mass added by the polymer layer be minimized to facilitate later processes. In any event, as best seen in FIG. 4, the polymer sheet 56 has an underside 58 which bonds to the topside 46 of the composite graphene/copper sheet so as to form a composite polymer/graphene/copper sheet 62 which is best seen in cross-section in FIG. 4. In most embodiments it is believed that the bond between the polymer sheet 56 and the composite graphene /copper sheet is a mechanical-type bond; however, it will be appreciated that a molecular bond may be provided upon proper selection of the polymer, the heat temperatures applied and any pre-treatment that may be applied to the composite graphene/copper sheet as it enters the polymer application device 50.

A copper removal device is designated generally by the number 70 and provides an inlet 72 for receiving the composite polymer/graphene/copper sheet 62. The device provides an outlet 74, which outputs a composite polymer/graphene sheet 80, which is also seen in FIG. 5. In one embodiment, the removal device etches away the copper material with a chemical solution. This process is done so as not to harm or appreciably degrade the graphene and/or polymer sheet. In some embodiments, the copper may be removed by electrochemical reaction with an appropriate concentration of ammonium persulfate solution. Other embodiments may use other materials to facilitate removal of the copper material. In another embodiment, sonic forces may be used to break the bonds between the graphene and copper material wherein the copper material is removed by a take-up reel or otherwise disposed. An exemplary process for utilizing this method is disclosed in U.S. Provisional Patent Application Ser. No. 61/787,035 filed on Mar. 15, 2013 and which is incorporated herein by reference. Control of the device 70 is provided by the controller 28 in a manner similar to the other components of the apparatus 20.

After the copper foil is removed, the composite polymer/graphene sheet 80 is cleaned, or otherwise treated, and then directed to a spiral wrapping device 82. The device 82 directs a scaffold tube 84 from a reel or other feeding mechanism (not shown). The scaffold tube may be constructed of a soluble polymeric material such as polyvinyl alcohol (PVA). In some embodiments other polymeric materials such as polyvinylchloride, polyethylene or the like may be used for the scaffold tube. Other non-polymeric materials may be used for the scaffold. Indeed, such materials may be tubular or may be solid. Other scaffolds may be metallic, such as copper and/or alloys thereof The resulting end product may be configured to allow removal by etching or other processes. Or the scaffold, tubular or solid, may be allowed to remain. As seen in FIG. 6A, the scaffold 84 may include a void 86. The composite polymer/graphene sheet 80 is spirally wrapped around the tube 84 so as to form a carbon macrotube 90 such that the one edge of the sheet overlaps an outer surface of polymer/graphene sheet previously wrapped on the tube. In such an embodiment the graphene sheet 42 is placed adjacent the scaffold 84. As such, the scaffold 84 and/or the sheet 80 are provided at appropriate intersecting angles so as to provide the desired width of overlap. Skilled artisans will appreciate that the amount of overlap can be adjusted as needed by adjusting the angle of intersection. As will be appreciated, a 90° angle of intersection between the tube and the opposed edges of the polymer/graphene sheet 80 will form a cylindrical roll of material around the tube. In other words, such an embodiment would provide for 100% overlap, that is, each lateral edge of the sheet 80 is aligned over and substantially flush with an underlying portion of the sheet. A reduced angle of intersection, say 85°, will result in a substantial overlap of the sheet that will have only slightly exposed edge of the sheet. A minimal angle of intersection, say 15°, will result in a minimal overlap of the sheet onto itself with a large portion of the sheet exposed. In some embodiments, a 0° angle of intersection may be employed. In such an embodiment, the tube 84 is oriented in parallel somewhere between the opposed width edges of the sheet. Such an embodiment may necessitate a width of the sheet compatible with a diameter of the tube and a folding mechanism to wrap the width edges around the tube. Although such reduced angles of intersection may be employed, it is believed that about a 50% overlap would provide an optimal configuration. In other words, a lateral edge of the sheet 80 would be positioned at about a mid-point of the underlying sheet. In some embodiments it will be appreciated that the sheet 80 may be directed to the spiral wrapping device 82 so that the polymer sheet 56 is placed adjacent the scaffold 84. In any event, the sheet 80 wrapped around the scaffold 84 is collected upon a take-up reel 92 wherein the resulting wrapping of the sheet around the scaffold 84 forms a carbon macrotube 90.

A cross-sectional view of the macrotube 90 is seen in FIG. 6A which shows the void from the scaffold 84 and an exemplary overlapping of the composite polymer/graphene sheet 80. As will be appreciated by skilled artisans, an edge of the sheet overlays an opposed edge of an underlying wrap of the sheet. In this manner, a continuous length of carbon macrotube 90 is formed. It will be appreciated that the speed of the rotation of the take-up reel 92 may also contribute or be a factor in the amount of overlap obtained by the wrapping operation.

In some embodiments, the scaffold tube may be further processed so as to remove it from the formed carbon macrotube. In one embodiment a solution is inserted into the tube so as to dissolve the polymeric material of the scaffold in such a manner that the resulting macrotube consists of just the graphene/polymer sheet as shown in FIG. 6B. If PVA is used as the material for the scaffold, then a water-based solution may be used as the solvent.

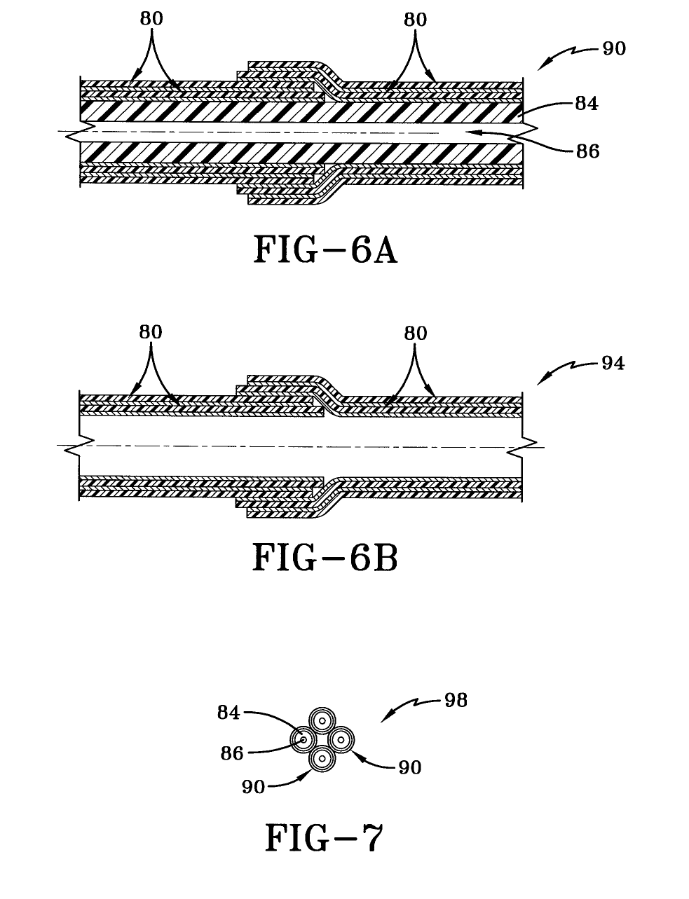

Referring now to FIG. 7, it will be appreciated that any one of the tubes 90, 94 or 96 may be further processed so as to cable the tubes to one another so as to form a cable 98. A cable 98 may consist of at least two tubes although it will be appreciated that any number of tubes could be formed. Moreover, any number of cables 98 may then be further cabled with other cables so as to form a more robust construction.

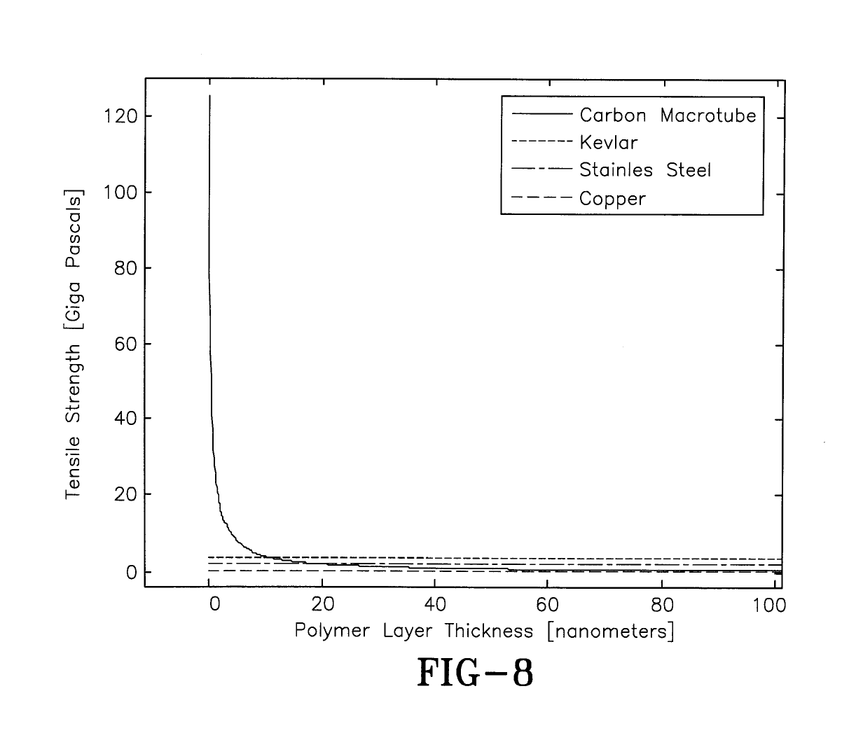

Referring now to FIGS. 8-11, it can be seen that an exemplary carbon macrotube constructed from the above process, wherein the resulting graphene sheet overlays itself in a spirally wrapped configuration has certain theoretical physical properties that are comparable to other high-strength materials. In these graphs, the values are based on the use of a theoretically perfect graphene sheet, that is, one without imperfections such as mis-aligned bonds and the like. These graphs are for illustrative purposes and comparable values are believed to be obtainable as the quality of graphene sheets is improved. In any event, the X-axis of these graphs show that as a polymer layer is reduced in thickness, the various properties of the exemplary macrotube shown approach the properties of a single walled carbon nanotube, but on an unlimited macro scale.

In FIG. 8, an exemplary carbon macrotube according to the concepts of the present invention provides for a tensile strength that is stronger than Kevlar and stainless steel. In this graph, only the tensile strength of a monolayer of graphene is shown, the strength contribution of the polymer is neglected. As the polymer layer is reduced in thickness, the tensile strength of the graphene monolayer approaches the strength of about 130 G pascals of a single-walled carbon nanotube. The analysis for such a construction is based on a measured 42 N/m breaking strength of a defect-free graphene monolayer sheet.

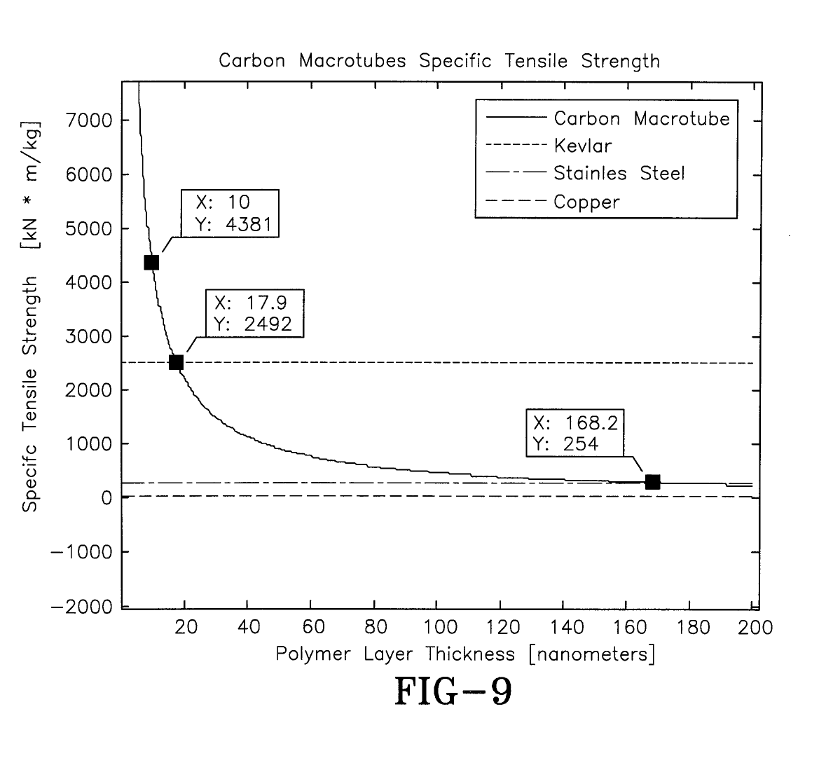

In FIG. 9 it can be seen that exemplary carbon macrotubes have a specific tensile strength which is substantially the same as stainless steel and improved over Kevlar™, provided an appropriate thickness of the graphene/polymer sheet is provided.

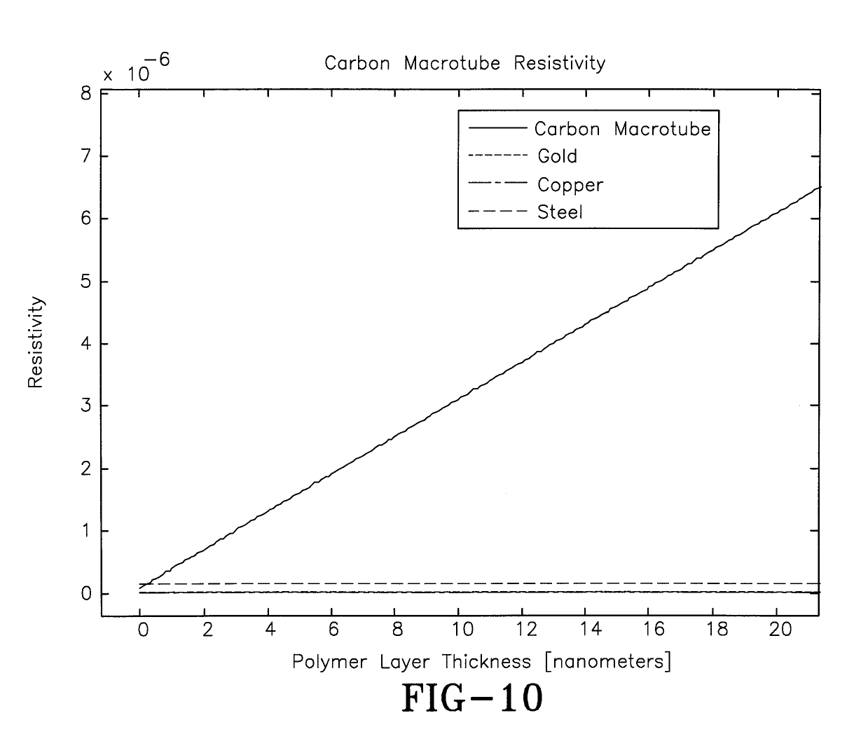

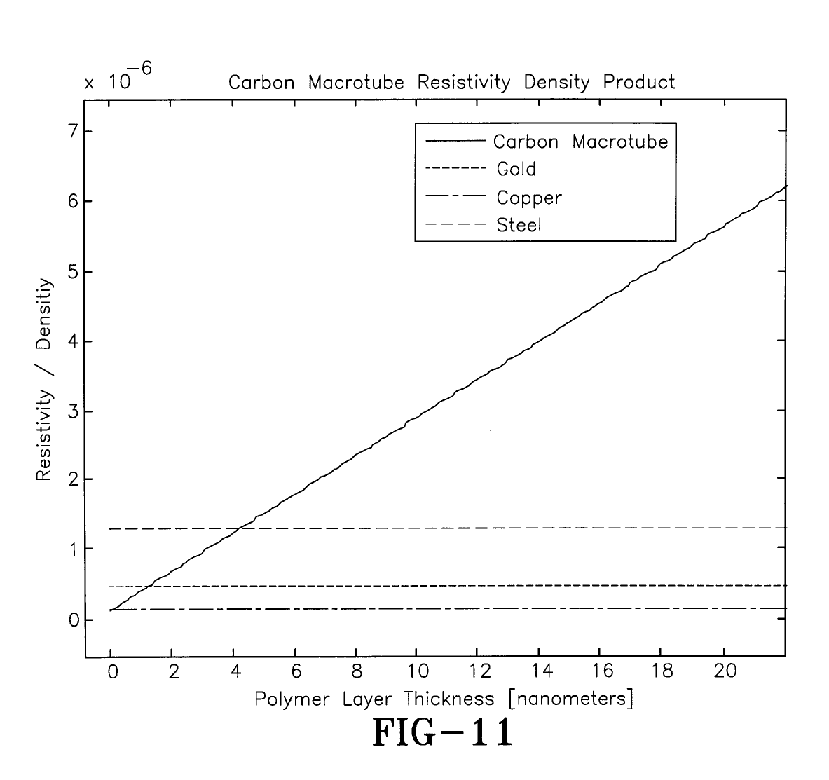

As seen in FIG. 10, an exemplary carbon macrotube construction has improved and significantly better resistivity properties as the thickness of the sheet is enlarged. The measurements shown are based on measured sheet resistivity of monolayer graphene disposed on a silicon oxide substrate. Referring to FIG. 11, it can be seen that an exemplary carbon macrotube resistivity density product is also much improved over the other materials such as gold, copper or steel.

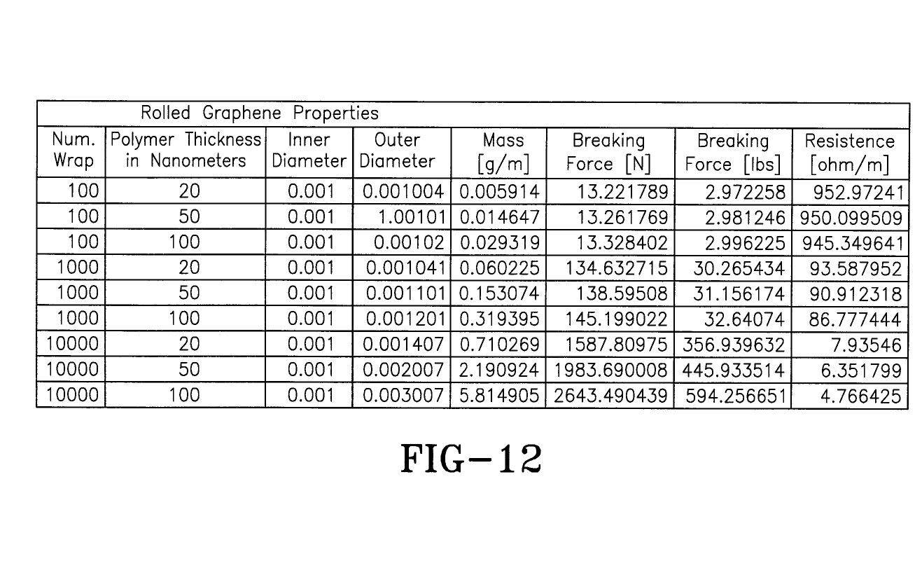

FIG. 12 provides a table of different constructions indicating the number of wraps ranging from one hundred to ten thousand and various parameters that are adjusted accordingly.

The advantages of the present invention are readily apparent. The apparatus 20 and resulting carbon macrotubes 90/94/96 provide for a macroscale structure with the mechanical and electrical properties similar to or better than carbon nanotubes by themselves by rolling graphene sheets to create macroscopic structures. Singular molecular chains of carbon bonds provided by the graphene provided in an unlimited length represents a very strong material with applications that include, but are not limited to, ultra-high tensile strength/lightweight structural materials used in aerospace components, armor and high-tension support cables and wires. It is also believed that the resulting disclosed macroscopic construction may result in lightweight electrical conductors used in high voltage power transmission lines, supports for tension and power data and a cable capable of supporting thin layered conductor/dielectric parallel and coaxial structures that transmit large data rates. The resulting construction provides for a combined lightweight strength material with promising electrical properties. It is believed that other applications utilizing the disclosed carbon macrotubes may also be realized.

Thus, it can be seen that the objects of the invention have been satisfied by the structure and its method for use presented above. While in accordance with the Patent Statutes, only the best mode and preferred embodiment has been presented and described in detail, it is to be understood that the invention is not limited thereto or thereby. Accordingly, for an appreciation of the true scope and breadth of the invention, reference should be made to the following claims.

What is claimed is:

1. A method of manufacturing a carbon macrotube, comprising:
providing at least one layer of graphene;
wrapping said at least one layer of graphene around a scaffold material so as to form a carbon macrotube.

2. The method according to claim 1, further comprising:
continuously providing said at least one layer of graphene;
continuously wrapping said at least one layer of graphene around said scaffold tube; and
pulling said at least one layer of graphene and said scaffold material on to a reel.

3. The method according to claim 2, further comprising:
dissolving said scaffold material.

4. The method according to claim 2, further comprising:
providing said scaffold material in tubular form.

5. The method according to claim 2, further comprising:
coupling a polymer layer to one side of said at least one layer of graphene; and
continuously wrapping said polymer layer and said at least one layer of graphene around said scaffold tube.

6. The method according to claim 5, further comprising:
continuously providing a copper foil;
continuously depositing carbon vapor on to said copper foil so as to form said at least one layer of graphene; and
coupling said polymer layer to one side of graphene opposite said copper foil.

7. The method according to claim 6, further comprising:
removing said copper foil from said at least one layer of graphene prior to the continuously wrapping step.

8. The method according to claim 1, further comprising:
weaving at least two said carbon macrotubes into a cable.

9. The method according to claim 1, further comprising:
overlapping said at least one layer of graphene on to said scaffold tube during the wrapping step.

10. A carbon macrotube, comprising:
at least one layer of graphene having opposed lateral edges, wherein said lateral edges are spirally wrapped around said at least one layer to form a macrotube.

11. The carbon macrotube according to claim 10, further comprising:
a scaffold material, wherein said at least one layer of graphene is spirally wrapped around said scaffold material.

12. The carbon macrotube according to claim 11, further comprising:
at least one layer of polymer disposed on said at least one layer of graphene, said at least one layer of graphene positioned adjacent said scaffold material.

13. The carbon macrotube according to claim 11, wherein said scaffold material is tubular.

14. The carbon macrotube according to claim 10, wherein at least one of said lateral edges overlaps a portion of said at least one layer of graphene.

15. The carbon macrotube according to claim 14, wherein said at least one lateral edge overlaps between 50% and 100% of said at least one layer of graphene.
